(19) United States
(12) Patent Application Publication
(10) Pub. No.: US 2014/0137624 A1
(43) Pub. Date: May 22, 2014

(54) DIE CUSHION SYSTEM AND METHOD

(71) Applicants: Kenneth L. Smedberg, Palos Heights, IL (US); Jesse N. Smedberg, Crete, IL (US)

(72) Inventors: Kenneth L. Smedberg, Palos Heights, IL (US); Jesse N. Smedberg, Crete, IL (US)

(21) Appl. No.: 13/968,093

(22) Filed: Aug. 15, 2013

Related U.S. Application Data
(60) Provisional application No. 61/683,687, filed on Aug. 15, 2012.

(51) Int. Cl. B21D 24/02; F16F 9/16; F16F 9/04

(52) U.S. Cl. CPC B21D 24/02; F16F 9/04; F16F 9/16
USPC 72/453.13; 100/102; 100/214; 267/130; 188/297

(57) ABSTRACT

The invention provides an aerocushion assembly in a power press having a frame. The power press includes a shape assembly; a shaft communicating with the shape assembly; a cushion assembly communicating with at least one of the shaft and the shape assembly, the cushion assembly preventing at least one of off-center loading of the shaft or deflection of the shaft during movement thereof; a snubbing assembly communicating with at least the shaft; and an adjustment assembly communicating with the shaft and adjusts a stroke length.

### CLAIM FOR PRIORITY

The present application claims the benefit of Provisional Application No. 61/683,687 filed Aug. 15, 2012 and titled “Die Cushion System and Method” the complete subject matter of which is incorporated herein by reference.

### FIELD OF THE INVENTION

The invention relates to a die cushion system and method. More particularly, the invention relates to a die cushion system used with a power press.

### BACKGROUND OF THE INVENTION

The die cushion is an air-actuated press accessory that is placed below or inside a bolster plate or die block, which is used to increase pressure on the die using pressure pins. The air cushion can also be used to lift the part out of the die. It is a workholding device.

Power presses are built in a wide variety of styles and sizes to perform a variety of functions, such as stamping, drawing, forming in addition to performing other functions. The deleterious effects of impact loading associated with many functions of power presses are well known and recognized. A variety of cushion arrangements for use in power presses is well known. Though cushioning improves operation of the power press, it is still necessary to provide a means to modulate the force applied by a press ram to the work piece and stationary portions of the press to further reduce the deleterious effect of undesired shock loading on parts of the press and to achieve a smooth application of force to a work piece.

It would therefore be desirable to have a fully adjustable assembly for removable and stationary rubber actuator support systems that overcomes the above disadvantages.

### SUMMARY OF THE INVENTION

One embodiment relates to a cushion assembly used in a power press having a moveable shaft. The cushion assembly includes a cushion box communicating with the shaft, preventing off-center loading of the shaft during movement thereof; and at least one bar communicating with the shaft, providing vertical alignment of the shaft by guiding the shaft and preventing deflection of the shaft during movement thereof.

Another embodiment relates to a snubbing assembly used with a power press having a moveable shaft. The snubbing assembly includes a hydraulic cylinder communicating with the shaft; and at least one leveling shim in communication with the hydraulic cylinder, enabling leveling of the hydraulic cylinder.

Another embodiment relates to a power press. The power press includes a moveable shaft; and an adjustment assembly communicating with the shaft and adjusts a stroke length of the shaft.

Still another embodiment relates to a power press having a frame. The power press includes a shape assembly; a shaft communicating with the shape assembly; a cushion assembly communicating with at least one of the shaft and the shape assembly, the cushion assembly preventing at least one of off-center loading of the shaft or deflection of the shaft during movement thereof; a snubbing assembly communicating with at least the shaft; and an adjustment assembly communicating with the shaft and adjusting a stroke length.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a power press in accordance with one embodiment of the present invention;

FIG. 2 depicts a power press and rolling bolster in accordance with one embodiment of the present invention;

FIG. 3 illustrates a cushion box assembly and an aerocushion assembly used with a power press of FIG. 1, the aerocushion assembly in an expanded position in accordance with one embodiment;

FIG. 4 illustrates the cushion box assembly and the aerocushion assembly used with a power press of FIG. 1, the aerocushion assembly in a compressed position in accordance with one embodiment;

FIG. 5 illustrates a partially exploded view of a power press used with a cushion/aerocushion assembly in accordance with one embodiment; and

FIG. 6 illustrates a power press used with a cushion/aerocushion assembly in accordance with one embodiment.

Throughout the various figures, like reference numbers refer to like elements.

### DETAILED DESCRIPTION OF PRESENTLY PREFERRED EMBODIMENTS

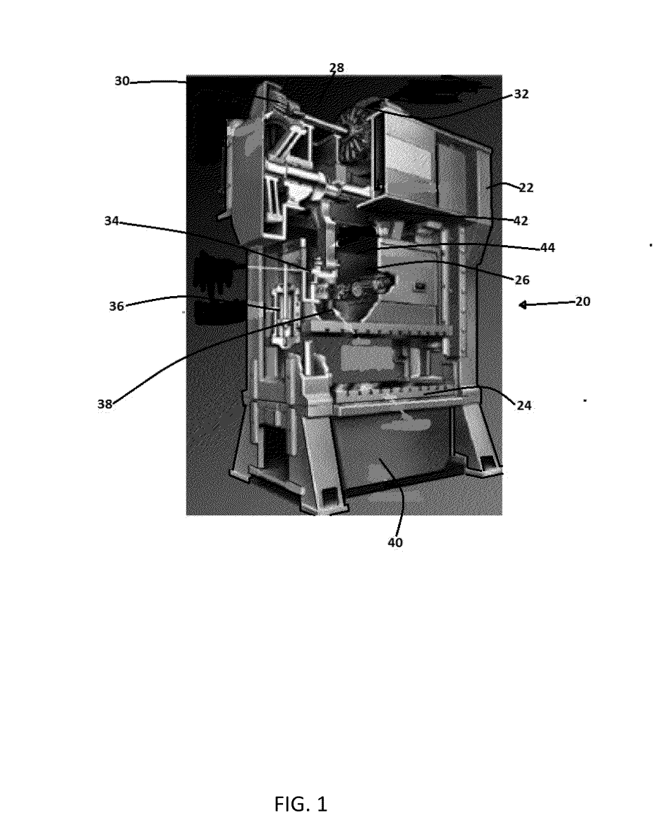

Referring now the drawings and especially to FIG. 1, a power press generally indicated by numeral 20 is shown. Power press 20 includes a frame 22 with a bolster 24 fixed within the frame 22. The bolster 24 is a stationary portion of the press. A slide or ram 26 is movably mounted in the frame and is driven by drive assembly 28 including opposed helical gears 30 located on one or more sides of the frame 22 and a flywheel clutch and brake 32 powered from a conventional power source not shown herein. As illustrated, the press 20 further includes saddle bushing 34, counterbalance cylinder 36, sheet height adjustment 38, press bed 40, eccentric shaft 42 and connection 44.

A shape assembly or die assembly (not shown) is mounted within the press 20. More particularly, the die assembly includes a lower die and a movable die ring positioned adjacent to and surrounding the lower die. In at least one embodiment, the die ring extends above lower die. An upper die of the die assembly is mateable with lower die. Upper die is fixed to the ram 26 to move up and down with the ram 26 within frame 22.

A work piece is positioned on top of the die ring. When the upper die moves down into engagement with work piece, the work piece is locked at its outer periphery between the upper die and the die ring. Further movement of the ram 26 causes the central portion of the work piece to be drawn around the lower die. After the ram has completed its downward stroke, the ram is moved upward, which allows the die ring to move upward, and disengage the work piece from the lower die. The work piece is then removed in a conventional and well known manner and a new work piece is positioned in the die.

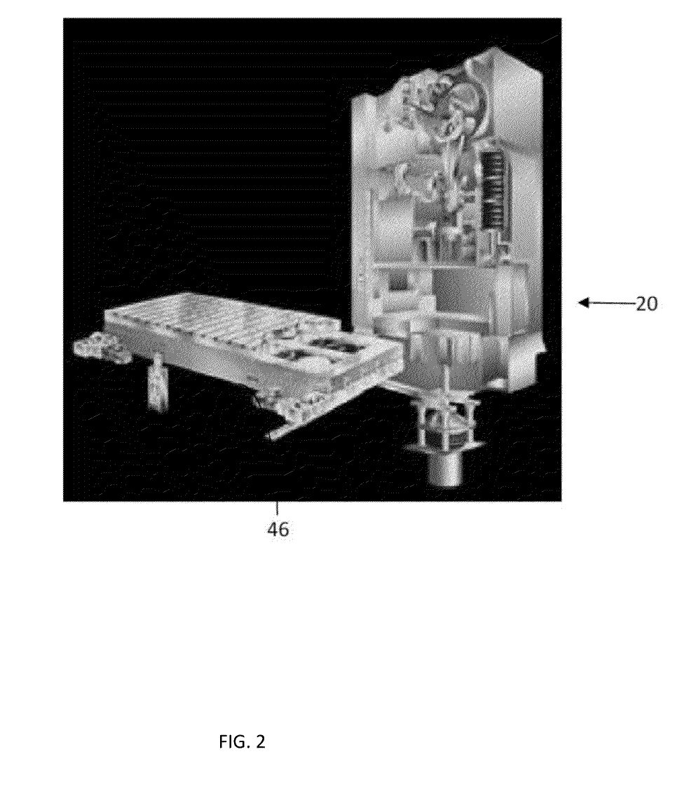

FIG. 2 depicts a power press 20 and rolling bolster 46 including actuators in accordance with one embodiment. The drive assembly 28 drives the ram 26 (with upper die attached) down to the die positioned on bolter 24 as provided previously. As the upper die comes in contact with the lower die (attached to the bolster 24) it comes in contact with the die ring positioned on pins. The pins are driven through the bolster 24 to the top or upper surface of the aerocusions.

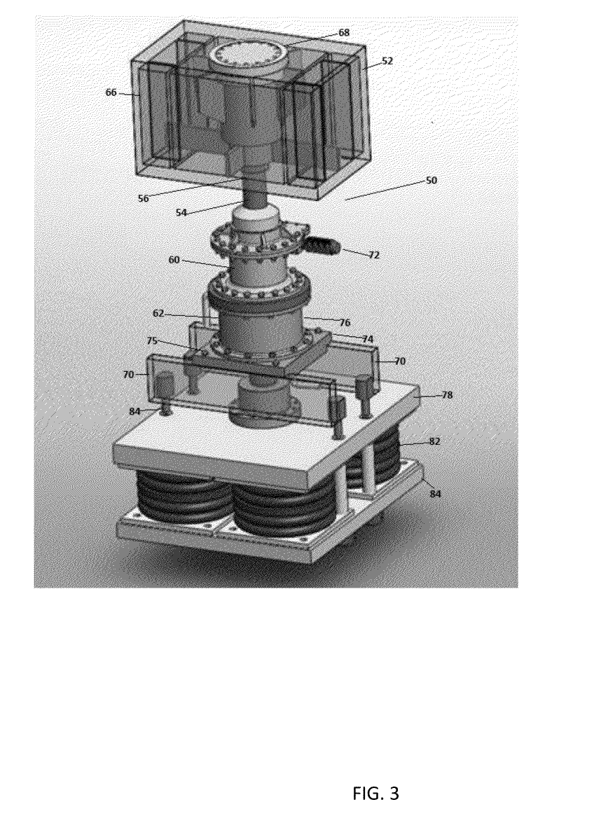

FIGS. 3-5 illustrate an embodiment of the present invention used with a power press and shape assembly similar to that provided previously. The aerocushion assembly 50, generally designated 50, provides a predetermined part holding force with the applied force from the ram 26 and/or shaft 54 (having a first end 56 and second end 58) to smooth out the force applied to the parts of the power press 20. Utilization of the predetermined force against the force of the ram 26 and/or shaft 54 reduces the deleterious effect of extraneous forces within the press generated by the ram 26 and/or shaft 54. The aerocushion assembly 50 creates the proper part holding force, which in turn reduces maintenance, reduces costs, reduces the number of required parts including spare parts; reduces or climates air loss, and makes operation easier.

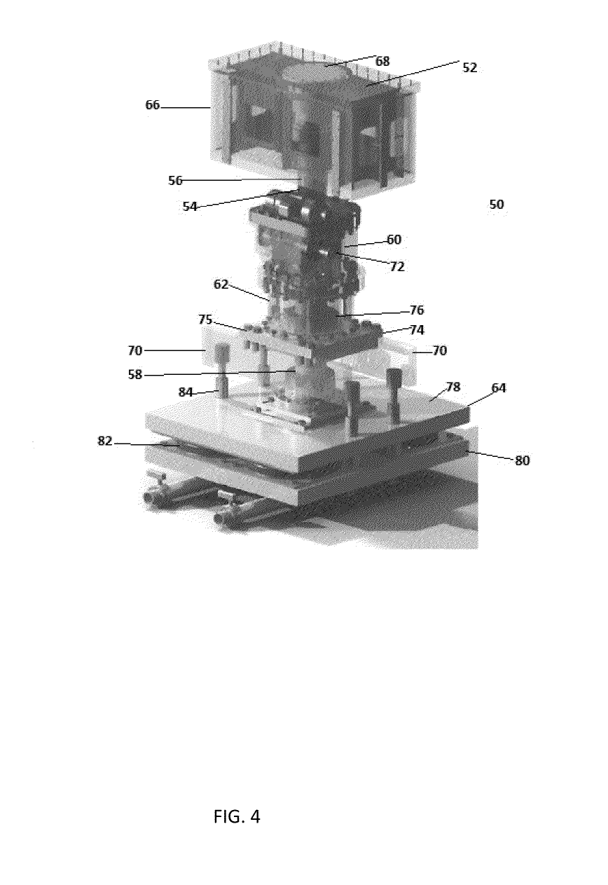

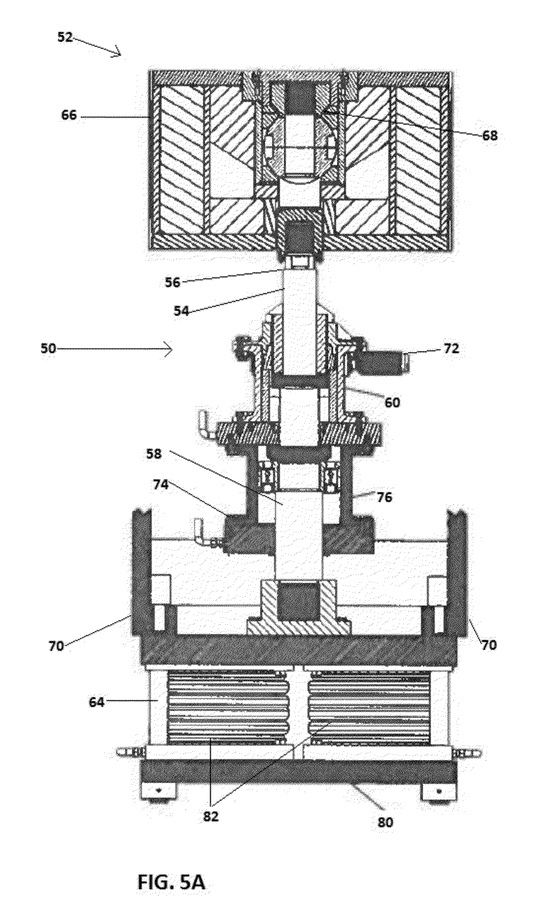

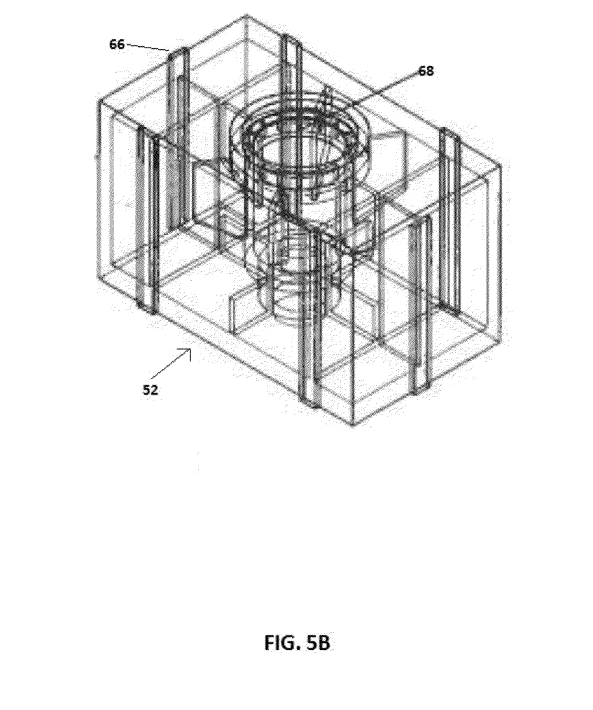

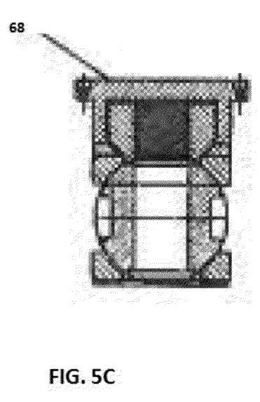

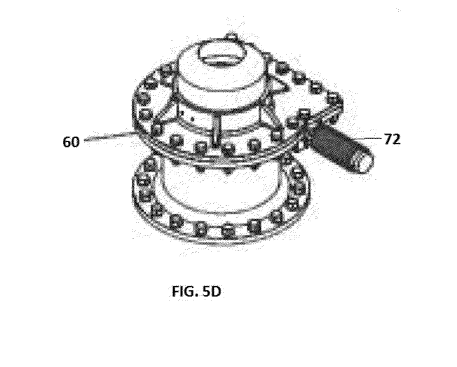

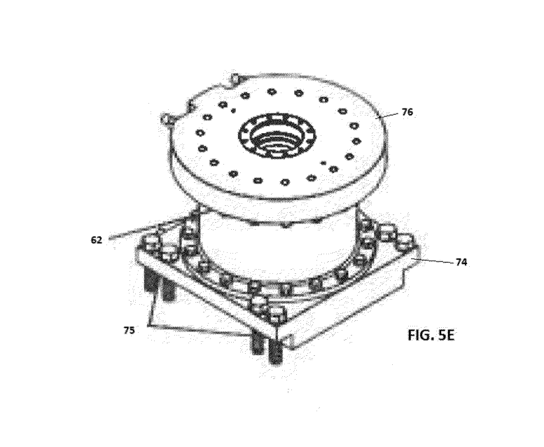

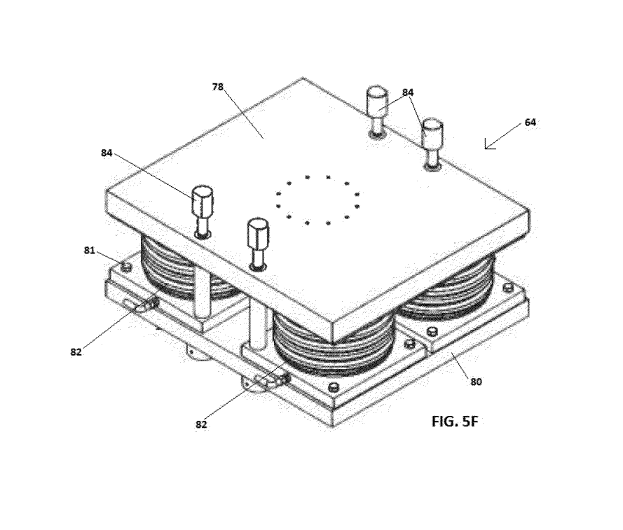

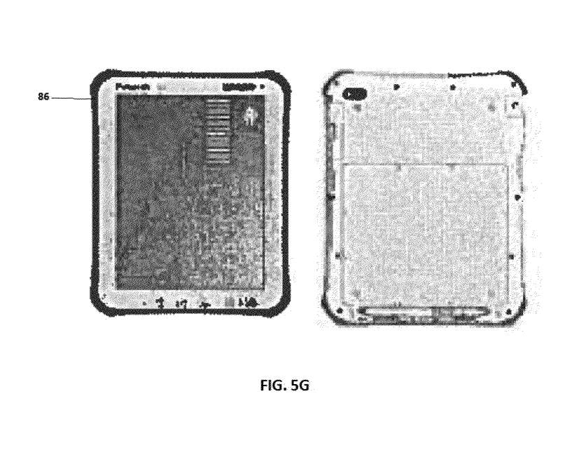

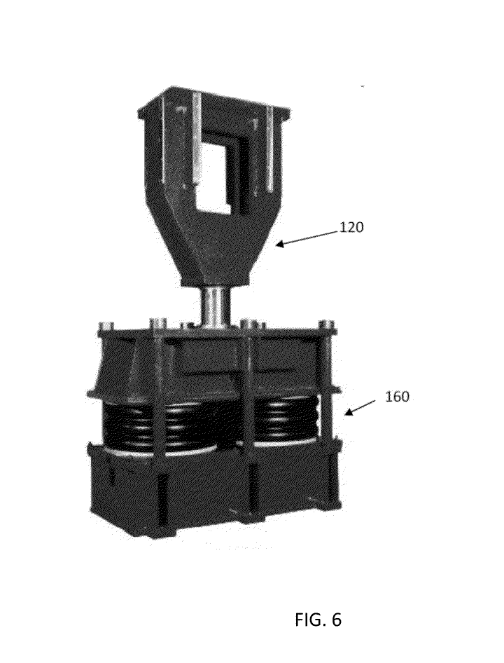

One embodiment of the aerocushion assembly 50 comprises a cushion assembly 52, an adjustment assembly 60, a snubbing assembly 62 and a die cushion assembly 64. FIG. 3 illustrates the aerocushion assembly 50 with the die cushion assembly 64 in an expanded position, while FIG. 4 depicts the aerocushion assembly 50 with the die cushion assembly 64 in a compressed position in accordance; and FIG. 5 illustrates a partially exploded view of the aerocushion assembly 50 in accordance with one embodiment. While one embodiment of the aerocushion assembly 50 is illustrated in FIGS. 3-4 having the arrangement of the cushion assembly 52, the shaft 54, the adjustment assembly 60, the snubbing assembly 62 and the die cushion assembly 64 in the order as is shown, other embodiments other embodiments and orders are contemplated, which may include one or more of the cushion assembly 52, the shaft 54, the adjustment assembly 56, the snubbing assembly 58 and/or the aerocushion assembly 60.

In the embodiment illustrated in FIGS. 3-5, the cushion assembly 52 comprises a housing or frame 66, a spherical bearing assembly 68 positioned in the housing 66 in communication with the first end 56 of the shaft 54, and/or at least one, but generally two or more bars or supports 70 proximate second end 58, where the cushion assembly 52 provides vertical alignment of the shaft 54 by preventing or restraining off-center movement and/or deflection created by movement of the shaft 54. In at least one embodiment, the shaft 54 communicates with the cushion assembly 52 and/or the spherical bearing assembly 68, where the cushion assembly 52 and/or spherical bearing 68 assembly prevents at least one of off-center loading of the shaft 54 or deflection of the shaft 54 during movement. More specifically, the cushion assembly 52 and/or the spherical bearing assembly 68 prevent the off-center loading of the shaft 54 in a plane substantially perpendicular to the shaft 54.

In at least one embodiment, the one or more bars or supports 70 (two bars or supports 70 are illustrated) are coupled to or joined to the frame 22. While two bars or supports 70 are illustrated, one or more than two are contemplated, where less than all or all of the bars or supports 70 are tied into the frame 22. The one or more bars or supports 70 provide vertical alignment of the shaft 554 by guiding the shaft 54 and preventing deflection during movement of the shaft 54 in a plane substantially perpendicular to the shaft 54.

The aerocushion assembly 50 includes the adjustment assembly 60 having an adjustment mechanism or handle 72 communicating with the shaft 54. The mechanism 72 is used to position the adjustment assembly 60, thereby adjusting the stroke length of the shaft 54. Adjusting the stroke length limits or controls the stroke length of the shaft 54, thereby adjusting the force need to move the shaft 54.

The aerocushion assembly 50 includes a snubbing assembly 62 coupled to a plate 74. In at least one embodiment the plate 74 is coupled to or in communication with the bars or supports 70 and/or the shaft 54. The snubbing assembly 62 coupled to a plate 74. In at least one embodiment the plate 74 is coupled to or in communication with the bars or supports 70 and/or the shaft 54. In at least one embodiment, the snubbing assembly 62 comprises a hydraulic cylinder 76 (best viewed in FIG. 5) communicating with the shaft 54 and at least one or more leveling shims 75 in communication with the hydraulic cylinder 76, enabling leveling of the hydraulic cylinder 76.

In one or more embodiments, the hydraulic cylinder 76 acts as a pre-acceleration hydraulic cylinder, a hydraulic shock cylinder and/or a locking hydraulic cylinder. In one or more embodiments, the hydraulic cylinder 76 takes some of the shock out of the mechanical motion created by at least the shaft, absorbs some of the shock created by at least the shaft and/or locks the shaft 54 enabling access to at least a portion of the power press.

Die cushion assembly 64 includes an upper plate 78 and a lower plate 80 spaced from the upper plate 78. Resilient conventional bellows 80 (four are illustrated) resiliently space the plates from each other. Four limiter pins 82 hold the plates 78, 80 substantially parallel to each other. Bellows 80 have their upper end communicating with the upper plate 78 and the lower end communicating with the lower plate 80.

The bellows 80 are identical in construction to each other. Each of the bellows includes a boot with a pair of rings mounted thereon. The boot has a top cap secured to the upper end of the boot with a seal to provide a sealing engagement between the top cap and the upper end of the boot. The top cap has fastener receptacles arranged in a circle. Each of the receptacles has an internal thread. A bottom cap is mounted on the bottom of each boot and is sealingly connected to the boot through an annular seal. The bottom cap has fastener receptacles arranged in a circle. Each of the fastener receptacles has an internal thread. Bottom cap includes a pipe aperture for receiving an air inlet pipe.

Upper plate 78 is a generally rectangular plate having a uniform thickness. Four threaded guide pin apertures are formed in the plate. Each of the guide pin apertures is adjacent to a corner of the plate. The upper plate 78 also contains screw receptacles.

Bottom plate 80 is similar to the upper plate 78. Bottom plate 80 is rectangular in shape and has four holes formed in its four corners. The holes are aligned with threaded holes of upper plate 78. Bottom plate 80 contains a pair of pipe apertures to receive pins connected to bellows 80.

Each of the limiter pins 82 is identical in construction to each of the other limiter pins. Each limiter pin has at one end a threaded portion which is threadedly mounted in each of the threaded apertures of upper plate 78. Each limiter pin has a cylindrical body with a threaded portion the other end for receiving a stop means. A limit sleeve is slidably mounted on the body of each limiter pin. Each limit sleeve is of a sufficient height to prevent bellows 80 from being damaged when plates 78 and 80 are moved toward each other. Limit sleeves define a minimum spacing between the plates so that when the bellows are collapsed, there is no danger of any damage to the bellows.

The aerocushion assembly 50 is mounted in the bed 40 (or in large presses below the floor) and in engagement with at least the slide or ram 26, lower die and or pins. When the upper or female portion moves down into engagement with work piece, the work piece is locked at its outer periphery between the upper die and the die ring. Further downward movement of the ram causes the central portion of the work piece to be drawn around the lower die. As the upper die comes in contact with the die ring resting on pins, the pins are driven through the bolster and into contact with the aerocushion 50.

The aerocushion 50 provides a predetermined part holding force with the applied force from the ram to smooth out the force applied to the parts of the power press. The utilization of the predetermined force against the force of the ram reduces the deleterious effect of extraneous forces within the press generated by the ram. The aerocushion 60 creates the proper part holding force, which in turn reduces maintenance, reduces costs, reduces the number of required parts including spare parts; reduces or climates air loss, and makes operation easier.

FIG. 4 further illustrates a wireless control interface 84 communicating with at least the aerocushion 50. In one or more embodiments, the press 20 includes one or more sensors communicating with at least one or more of the drive assembly, ram, cushion box, aerocushion assembly, among other elements. In one embodiment, the one or more sensors measures or senses operating parameters of least the one or more of the drive assembly, ram, cushion box, aerocushion assembly 60, among other elements, and communicates (wirelessly for example) directly or through a cloud environment for example with the control interface 70. The embodiment may include diagnostic software providing operation and maintenance information thereto.

FIG. 5 illustrates a view of a power press 120 used with a cushion/aerocushion assembly 160 in accordance with one embodiment.

One or more embodiments of the invention may include a quick change plate, a center shaft guidance fixture (one or more steel plates tied to the press; off center loading (an upper portion of the aerocushion is located in the bed, the shaft between the upper and lower cushion is contained in a split bearing and the shaft is supported by a cross member).

Yet other embodiments relate to a method for operating the power press 20/120 and/or aerocushion 60/160. The method comprises driving the slide and upper die towards the lower die using the gear mechanism; driving pins into contact with at least the first steel plate. The method further comprises creating the proper part holding force using the aerocushion, reducing maintenance, costs, the number of required parts including spare parts; air loss, and makes operation easier.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A cushion assembly used in a power press having a moveable shaft, the cushion assembly comprising:
a cushion box communicating with the shaft, preventing off-center loading of the shaft during movement thereof; and
at least one bar communicating with the shaft, providing vertical alignment of the shaft by guiding the shaft and preventing deflection of the shaft during movement thereof.

2. The cushion assembly of claim 1 wherein the cushion box includes a spherical assembly communicating with the shaft, preventing off-center loading of the shaft during movement thereof.

3. The cushion assembly of claim 1 further comprises at least two opposing bars communicating with the shaft, preventing deflection of the shaft during movement thereof.

4. The cushion assembly of claim 1 wherein the at least one bar is connected to a frame of the power press.

5. A snubbing assembly used with a power press having a moveable shaft, the snubbing assembly comprising:
a hydraulic cylinder communicating with the shaft; and
at least one leveling shim in communication with the hydraulic cylinder, enabling leveling of the hydraulic cylinder.

6. The snubbing assembly of claim 5 wherein the hydraulic cylinder comprises a pre-acceleration hydraulic cylinder that takes some of the shock out of the mechanical motion created by at least the shaft.

7. The snubbing assembly of claim 5 wherein the hydraulic cylinder comprises a hydraulic shock cylinder that absorbs some of the shock created by at least the shaft.

8. The snubbing assembly of claim 5 wherein the hydraulic cylinder comprises a locking hydraulic cylinder that locks the shaft, enabling access to at least a portion of the power press.

9. A power press comprising:
a moveable shaft;
an adjustment assembly communicating with the shaft and adjusts a stroke length of the shaft.

10. A power press having a frame, the power press comprising:
a shape assembly;
a shaft communicating with the shape assembly;
a cushion assembly communicating with at least one of the shaft and the shape assembly, the cushion assembly preventing at least one of off-center loading of the shaft or deflection of the shaft during movement thereof;
a snubbing assembly communicating with at least the shaft; and
an adjustment assembly communicating with the shaft and adjusting a stroke length.

11. The power press of claim 10 wherein the cushion assembly comprises a cushion box communicating with the shaft, preventing off-center loading of the shaft during movement thereof; and at least one bar communicating with the shaft, providing vertical alignment of the shaft by guiding the shaft and preventing deflection of the shaft during movement thereof.

12. The cushion assembly of claim 11 wherein the cushion box includes a spherical assembly communicating with the shaft, preventing off-center loading of the shaft during movement thereof.

13. The cushion assembly of claim 11 further at least two opposing bars communicating with the shaft, preventing deflection of the shaft during movement thereof.

14. The cushion assembly of claim 13 wherein the at least one of the two bars is connected to a frame of the power press.

15. The power press of claim 11 wherein the snubbing assembly comprises a hydraulic cylinder communicating with the shaft; and at least one leveling shim in communication with the hydraulic cylinder, enabling leveling of the hydraulic cylinder.

16. The power press of claim 15 wherein the hydraulic cylinder comprises a pre-acceleration hydraulic cylinder that takes some of the shock out of the mechanical motion created by at least the shaft.

17. The power press of claim 15 wherein the hydraulic cylinder comprises a hydraulic shock cylinder that absorbs some of the shock created by at least the shaft.

18. The power press of claim 15 wherein the hydraulic cylinder comprises a locking hydraulic cylinder that lock the shaft, enabling access to at least a portion of the power press.

19. The power press of claim 10 further including an die cushion assembly comprising:
a first steel plate;
a second steel plate spaced from and substantially parallel to the first steel plate;
at least one rubber pneumatic bellows mounted to at least one of the first steel plate and the second steel plate and holding the first steel plate and second steel plate apart in a resilient manner.

20. The power press of claim 10 wherein the shape assembly comprises
a slide;
an upper die coupled to the slide;
a bolster;
a lower die positioned on the bolster; and
a gear mechanism.
